(19) United States
(12) Patent Application Publication
(10) Pub. No.: US 2024/0258635 A1
(43) Pub. Date: Aug. 1, 2024

(54) BATTERY ASSEMBLY AND METHOD OF MANUFACTURING SAME

(71) Applicant: Prime Planet Energy & Solutions, Inc., Tokyo (JP)

(72) Inventors: Tetsuji OMURA, Kobe-shi (JP); Ryosuke IWATA, Kobe-shi (JP); Shigeki MATSUTA, Kobe-shi (JP)

(73) Assignee: Prime Planet Energy & Solutions, Inc., Tokyo (JP)

(21) Appl. No.: 18/426,820

(22) Filed: Jan. 30, 2024

(30) Foreign Application Priority Data
Jan. 31, 2023 (JP) 2023-012614

(51) Int. Cl. H01M 50/291; H01M 10/6555; H01M 10/658; H01M 50/209; H01M 50/264; H01M 50/293

(52) U.S. Cl. CPC H01M 50/291; H01M 10/6555; H01M 10/658; H01M 50/209; H01M 50/264; H01M 50/293

(57) ABSTRACT

A battery assembly includes: a plurality of battery cells arranged in a first direction; a separator disposed between the plurality of battery cells; a restraint member that restrains the plurality of battery cells and the separator along the first direction, wherein the separator includes a first member including a base portion and a plurality of protrusions each protruding from the base portion in the first direction, and a second member disposed between the plurality of protrusions, the second member having a higher heat insulation property than a heat insulation property of the first member, the second member being more likely to be deformed than the first member.

### CROSS REFERENCE TO RELATED APPLICATIONS

This nonprovisional application is based on Japanese Patent Application No. 2023-012614 filed on Jan. 31, 2023 with the Japan Patent Office, the entire contents of which are hereby incorporated by reference.

### BACKGROUND OF THE INVENTION

### Field of the Invention

The present technology relates to a battery assembly and a method of manufacturing the battery assembly.

### Description of the Background Art

In Chinese Utility Model No. 215119123, a structure in which a heat insulating material and an elastic body are placed on each other is disclosed as a structure of a separator disposed between a plurality of battery cells. Japanese Patent Laying-Open No. 2021-150079 discloses an elastic body in which a hard portion protrudes from a through hole of a soft portion.

### SUMMARY OF THE INVENTION

Since the separator described in Chinese Utility Model No. 215119123 employs the two-layer structure with the heat insulating material and the elastic body, a total of a tolerance of the thickness of the heat insulating material and a tolerance of the thickness of the elastic body is a tolerance of the thickness of the separator.

Therefore, the tolerance of the thickness of the separator tends to be larger than that of a separator constituted of one member. When the thickness of the separator is large, a restraint load on battery cells become large even though design values of sizes of the battery cells in a stacking direction are the same. When the maximum value of the restraint load on the battery cells becomes large, strength of a strength member in the battery module needs to be improved, which can lead to increased weight and increased cost of the battery module.

In the elastic body described in Japanese Patent Laying-Open No. 2021-150079, the soft portion is normally separated from an electrode assembly in a state in which it is incorporated in a secondary battery module. Further, since the hard portions interspersed in the elastic body are likely to be deformed, it is considered that a load is received from the electrode assembly.

It is an object of the present technology to provide: a battery assembly in which variation in reaction force acting on a battery cell is small; and a method of manufacturing the battery assembly.

The present technology provides the following battery assembly and method of manufacturing the battery assembly.
[1] A battery assembly comprising: a plurality of battery cells arranged in a first direction; a separator disposed between the plurality of battery cells; and a restraint member that restrains the plurality of battery cells and the separator along the first direction, wherein the separator includes a first member including a base portion and a plurality of protrusions each protruding from the base portion in the first direction, and a second member disposed between the plurality of protrusions, the second member having a higher heat insulation property than a heat insulation property of the first member, the second member being more likely to be deformed than the first member.
[2] The battery assembly according to [1], wherein in a state in which the separator is detached from the battery assembly, a protruding height of each of the plurality of protrusions is larger than a thickness of the second member.
[3] The battery assembly according to [1] or [2], wherein an outer size of the first member and an outer size of the second member are substantially equal to each other.
[4] The battery assembly according to any one of [1] to [3], wherein the base portion of the first member and the plurality of protrusions are integrally molded.
[5] The battery assembly according to any one of [1] to [4], wherein the second member is composed of a foamed resin.
[6] A method of manufacturing a battery assembly, the method comprising: preparing a plurality of battery cells and a separator; arranging the plurality of battery cells and the separator alternately in a first direction; and restraining the plurality of battery cells and the separator along the first direction, wherein the preparing of the separator includes preparing a first member including a base portion and a plurality of protrusions protruding from the base portion in the first direction, and providing a second member disposed between the plurality of protrusions, the second member having a higher heat insulation property than a heat insulation property of the first member, the second member being more likely to be deformed than the first member, and the preparing of the first member includes causing a protruding height of each of the plurality of protrusions to be larger than a thickness of the second member.
[7] The method of manufacturing the battery assembly according to [6], wherein the preparing of the separator includes disposing the second member composed of a foamed resin between the plurality of protrusions of the first member by foaming a resin in a recess surrounded by a series of the protrusions of the first member.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a battery assembly.

FIG. 2 is a perspective view of a battery cell.

FIG. 3 is a perspective view of a battery module.

FIG. 4 is a cross sectional view of a separator included in the battery assembly.

FIG. 5 is a diagram showing a state in which the separator shown in FIG. 4 is disposed between battery cells.

FIG. 6 is a top view of a first member of the separator.

FIG. 7 is a top view of a second member of the separator.

FIG. 8 is a cross sectional view of a separator according to a comparative example.

FIG. 9 is a diagram showing a state in which the separator shown in FIG. 8 is disposed between battery cells.

FIG. 10 is a top view of a separator according to a modification.

FIG. 11 is a cross sectional view along XI-XI in FIG. 10.

FIG. 12 is a diagram showing deformation when a load is applied to the first member of the separator.

FIG. 13 is a diagram showing deformation when a load is applied to the second member of the separator.

FIG. 14 is a graph showing an exemplary load-thickness curve of each of the first member and the second member in the separator.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery.

In the present specification, the term “battery cell” is not necessarily limited to a prismatic battery cell and may include a cell having another shape, such as a cylindrical battery cell, a pouch battery cell, or a blade battery cell. Further, the “battery cell” can be mounted on vehicles such as a hybrid electric vehicle (HEV), a plug-in hybrid electric vehicle (PHEV), and a battery electric vehicle (BEV). It should be noted that the use of the “battery cell” is not limited to the use in a vehicle.

FIG. 1 is a perspective view of a battery assembly 1A. Battery assembly 1A shown in FIG. 1 includes battery cells 100 and separators 200 (inter-cell separator). Battery cells 100 and separators 200 are alternately arranged along a Y axis direction (first direction).

The plurality of battery cells 100 are battery cells each having a prismatic shape, and are provided along the Y axis direction. The plurality of battery cells 100 are electrically connected together by a bus bar (not shown).

Separators 200 are provided between the plurality of battery cells 100. Each of separators 200 prevents unintended electrical conduction between adjacent battery cells 100. Separator 200 secures an electrical insulation property between adjacent battery cells 100.

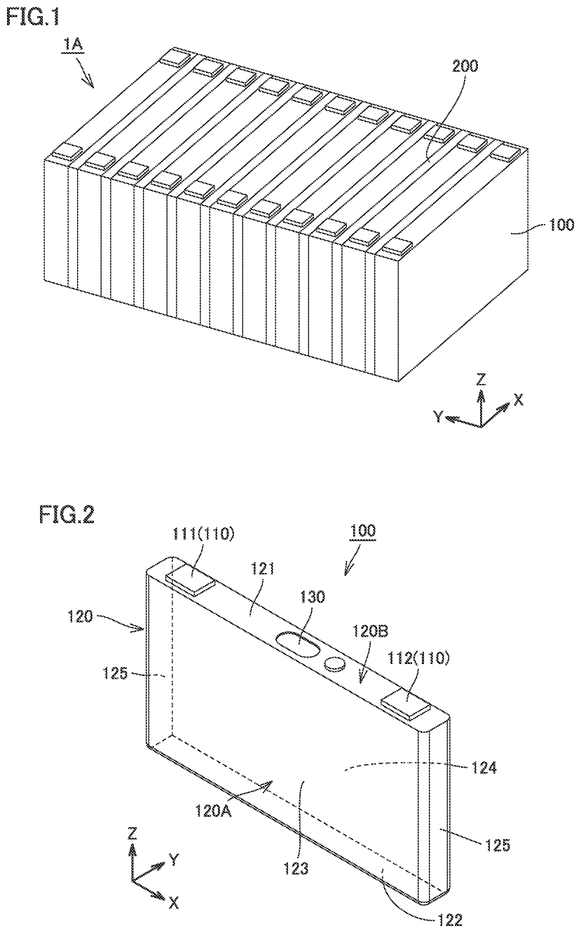

FIG. 2 is a perspective view of each battery cell 100. As shown in FIG. 2, battery cell 100 has a prismatic shape. Battery cell 100 has electrode terminals 110, a battery case 120, and a gas-discharge valve 130.

Electrode terminal 110 is formed on battery case 120. Electrode terminals 110 have a positive electrode terminal 111 and a negative electrode terminal 112 arranged side by side along an X axis direction (second direction) orthogonal to the Y axis direction (first direction). Positive electrode terminal 111 and negative electrode terminal 112 are provided to be separated from each other in the X axis direction.

Battery case 120 has a rectangular parallelepiped shape and forms an external appearance of battery cell 100. Battery case 120 includes: a case main body 120A that accommodates an electrode assembly (not shown) and an electrolyte solution (not shown); and a sealing plate 120B that seals an opening of case main body 120A. Sealing plate 120B is joined to case main body 120A by welding.

Battery case 120 has an upper surface 121, a lower surface 122, a first side surface 123, a second side surface 124, and two third side surfaces 125.

Upper surface 121 is a flat surface orthogonal to a Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of battery case 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

The plurality of battery cells 100 are stacked such that first side surfaces 123 of battery cells 100, 100 adjacent to each other in the Y direction face each other and second side surfaces 124 of battery cells 100, 100 adjacent to each other in the Y axis direction face each other. Thus, positive electrode terminals 111 and negative electrode terminals 112 are alternately arranged in the Y axis direction in which the plurality of battery cells 100 are stacked.

Gas-discharge valve 130 is provided in upper surface 121. When the temperature of battery cell 100 is increased (thermal runaway) and internal pressure of battery case 120 becomes more than or equal to a predetermined value due to gas generated inside battery case 120, gas-discharge valve 130 discharges the gas to outside of battery case 120.

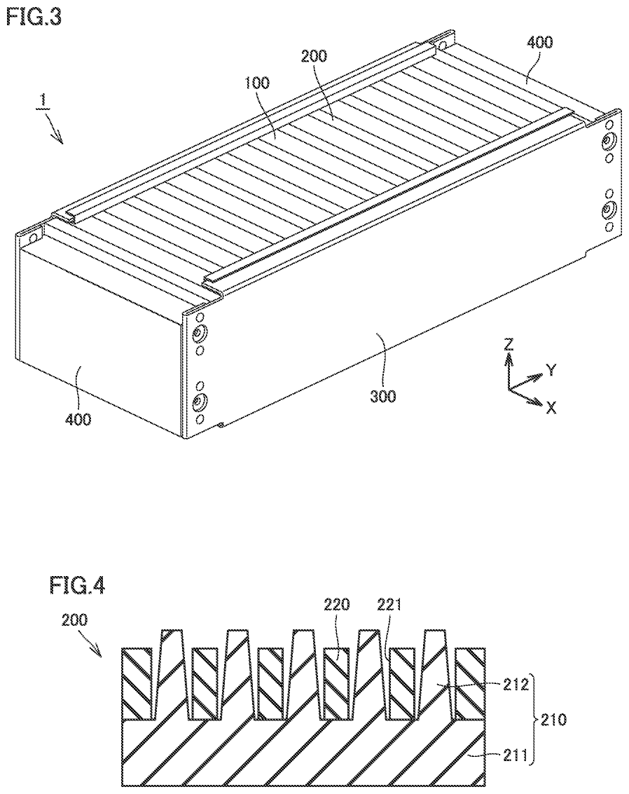

FIG. 3 is a perspective view of battery module 1. As shown in FIG. 3, battery module 1 includes battery cells 100, separators 200, restraint members 300, and end plates 400.

Battery cells 100 and separators 200 alternately arranged along the Y axis direction (first direction) are pressed by end plates 400 and are restrained between two end plates 400.

End plates 400 are disposed at both ends in the Y axis direction. Each of end plates 400 is fixed to a base such as a case that accommodates battery module 1. Restraint member 300 connects two end plates 400 to each other to restrain the plurality of battery cells 100 and separators 200 along the Y axis direction.

Restraint member 300 is fixed to end plates 400 with a compression force in the Y axis direction being exerted to the stack of battery cells 100, separators 200 and end plates 400, and then the compression force is released, with the result that tensile force acts on restraint member 300 that connects two end plates 400 to each other. As a reaction thereto, restraint members 300 press two end plates 400 in directions of bringing them closer to each other. In this way, battery module 1 is constructed.

By accommodating battery module 1 in a pack case, a battery pack is formed (cell-module-pack structure). Instead of this, a structure (cell-to-pack structure) may be employed in which battery assembly 1A shown in FIG. 1 is directly supported by a wall surface of the pack case.

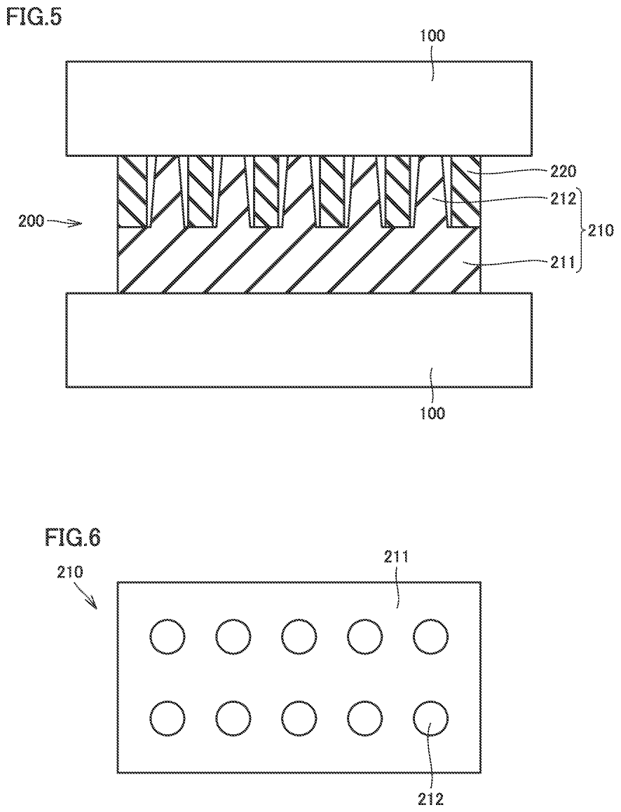

FIG. 4 is a cross sectional view of each separator 200. FIG. 5 is a diagram showing a state in which separator 200 shown in FIG. 4 is disposed between battery cells 100. FIG. 6 is a top view of a first member 210, and FIG. 7 is a top view of a second member 220.

As shown in FIGS. 4 to 7, separator 200 includes first member 210 and second member 220. First member 210 and second member 220 are placed on each other in the stacking direction (Y axis direction) of the plurality of battery cells 100.

First member 210 includes a base portion 211 and a plurality of protrusions 212 protruding from base portion 211 in the Y axis direction. Each of protrusions 212 has a tapered shape having a diameter that is decreased toward its tip. In the example of FIG. 4, base portion 211 and the plurality of protrusions 212 are integrally molded, but base portion 211 and protrusions 212 provided as separate members may be joined together.

Second member 220 is provided with hole portions 221. Protrusions 212 of first member 210 are inserted into hole portions 221 of second member 220. As a result, second member 220 is located between the plurality of protrusions 212. As an example, the outer size of first member 210 and the outer size of second member 220 are substantially equal to each other.

Typically, as shown in FIG. 4, in a state in which separator 200 is detached from battery assembly 1A, a protruding height of each of the plurality of protrusions 212 is larger than a thickness of second member 220. It should be noted that the scope of the present technology is not limited thereto. After separators 200 each shown in FIG. 4 are prepared, the plurality of battery cells 100 and separators 200 are alternately arranged in the Y axis direction and are restrained along the Y axis direction. On this occasion, as shown in FIG. 5, protrusions 212 of first member 210 are compressed together with second member 220.

First member 210 can be composed of an elastic body. First member 210 can be composed of, for example, a silicone rubber, a fluororubber, a urethane rubber, a natural rubber, a styrene-butadiene rubber, a butyl rubber, an ethylene propylene rubber (EPM, EPDM), a butadiene rubber, an isoprene rubber, a norbornene rubber, or the like (is preferably composed of the silicone rubber or fluororubber).

First member 210 is preferably composed of a material having an elastic modulus of about 1 MPa or more and 10 MPa or less as measured by the following method.

### Method of Measuring Elastic Modulus

(1) A square test piece having each side of 5 cm (surface facing the battery cell) is prepared.
(2) For the test piece, a load displacement curve (F-S curve) is obtained up to a pressure application force of 3.9 MPa (pressure application rate: 30 N/min).
(3) In a graph in which the horizontal axis represents a compression ratio and the vertical axis represents a pressure, the elastic modulus is calculated from the slope of a compression ratio of 1% to 20%.

Further, it is preferable to form first member 210 using such a material that a sample thickness measured by a micrometer with resting of two hours after the pressure application test (after unloading) is about −20% or less from an initial state (before the pressure application test).

Second member 220 has such a property that second member 220 has a higher heat insulation property than that of first member 210 and is more likely to be deformed than first member 210.

Second member 220 can be composed of a foamed resin. Second member 220 can be composed of, for example, an inorganic fiber (ceramic fiber or the like), a molding of an inorganic fiber and an organic binder, an inorganic filler and an organic binder, a foamed silicon sheet having a space therein, or the like.

Second member 220 preferably has a heat insulation property of about 0.15 W/mK or less, and more preferably has a heat insulation property of about 0.1 W/mK or less.

As shown in FIGS. 4 to 7, since separator 200 has the two-layer structure with first member 210 having a higher elastic modulus and second member 220 having a higher heat insulation property, both deformation absorption property and heat insulation property in separator 200 can be achieved.

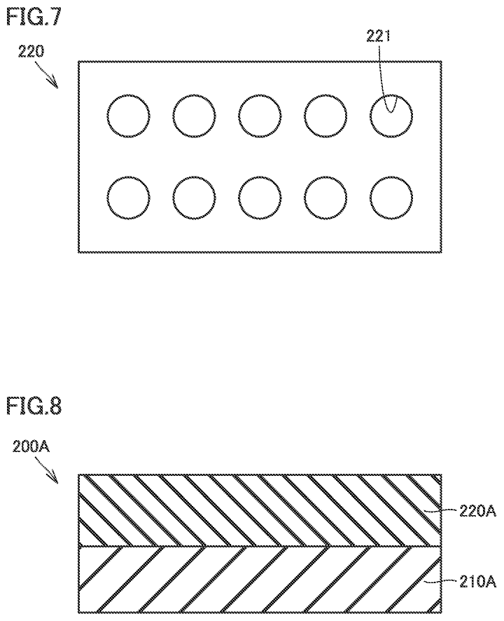

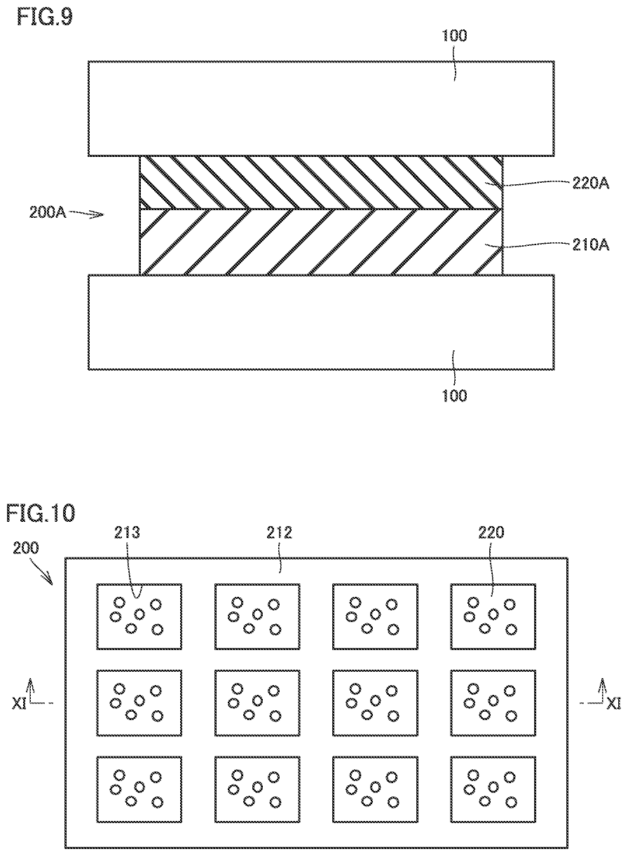

FIG. 8 is a cross sectional view of a separator 200A according to a comparative example. FIG. 9 is a diagram showing a state in which separator 200A shown in FIG. 8 is disposed between battery cells 100.

In separator 200A shown in FIGS. 8 and 9, a two-layer structure is disclosed in which a first member 210A having a higher elastic modulus and a second member 220A having a higher heat insulation property are placed on each other.

Since separator 200A employs the two-layer structure with first member 210A and second member 220A, a total of a tolerance of the thickness of first member 210A and a tolerance of the thickness of second member 220A is a tolerance of the thickness of separator 200A.

Thus, with the total of the tolerances of the thicknesses of the two members, the tolerance of the thickness of the separator becomes larger than that of a separator constituted of one member. As a result, a restraint load on battery cells 100 and separator 200A becomes large depending on the thickness of separator 200A even though design values of sizes of battery cells 100 in the stacking direction (Y axis direction) are the same. As a result, strength of a strength member in battery assembly 1A or battery module 1 needs to be improved, which can lead to increased weight and increased cost of battery module 1.

On the other hand, in separator 200 according to the present embodiment, since the structure is employed in which second member 220 is provided between protrusions 212 of first member 210, only the size tolerance of first member 210 of first member 210 and second member 220 needs to be managed, with the result that variation in the thickness of separator 200 becomes small as a whole. As a result, battery module 1 in which variation in reaction force acting on battery cell 100 is small is provided, thus contributing to reduced weight or reduced manufacturing cost of the battery module.

FIG. 10 is a top view of a separator 200 according to a modification. FIG. 11 is a cross sectional view along XI-XI in FIG. 10.

In the modification shown in FIGS. 10 and 11, a foam having an air layer therein is used as each second member 220. When preparing separator 200, a resin is foamed in a recess 213 surrounded by a series of protrusions 212 of first member 210. As a result, second member 220 composed of the foamed resin is formed between the plurality of protrusions 212 of first member 210.

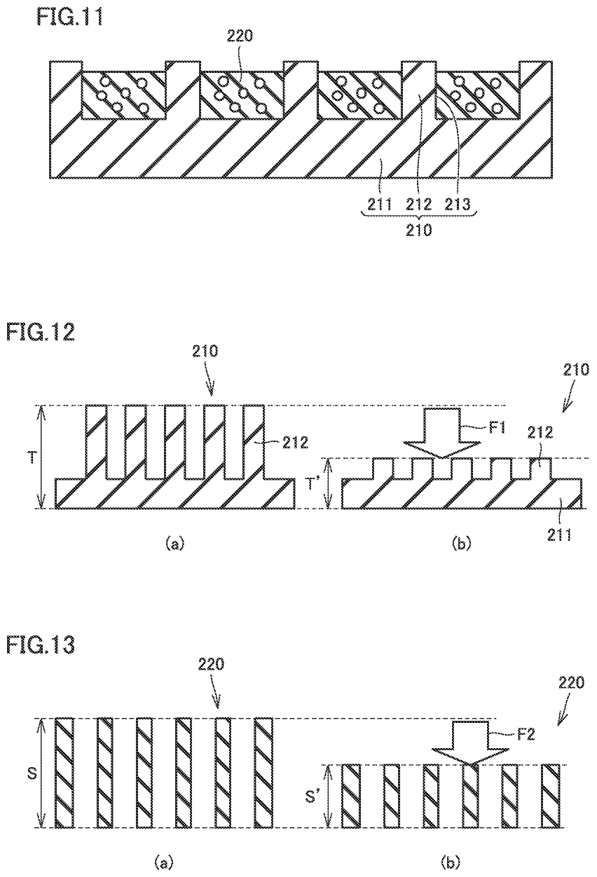

Next, a relation between the elastic modulus of first member 210 and the elastic modulus of second member 220 will be described with reference to FIGS. 12 to 14.

FIG. 12 is a diagram showing deformation when a load is applied to first member 210 of separator 200. FIG. 13 is a diagram showing deformation when a load is applied to second member 220 of separator 200.

As shown in FIG. 12, when first member 210 having a thickness T under application of no load is fed with a load F1, protrusions 212 are mainly compressed and deformed, with the result that the thickness of first member 210 is decreased to T′.

As shown in FIG. 13, when second member 220 having a thickness S under application of no load is fed with a load F2, second member 220 is compressed and deformed, with the result that the thickness of second member 220 is decreased to S′.

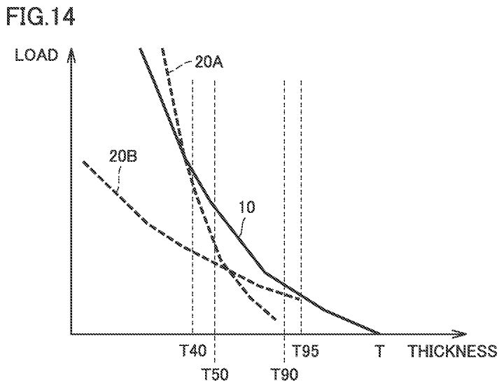

FIG. 14 is a graph showing an exemplary load-thickness curve of each of first member 210 and second member 220 in separator 200. In FIG. 14, a curve 10 is an exemplary load-thickness curve of first member 210 in separator 200, and each of curves 20A, 20B is an exemplary load-thickness curve of second member 220 in separator 200. In FIG. 14, the vertical axis represents a load acting on each of first member 210 and the second member in separator 200, and the horizontal axis represents the thickness of separator 200 (first member 210).

As indicated by curves 10, 20A, 20B in FIG. 14, each of the loads acting on first member 210 and second member 220 in separator 200 is increased as the thickness of separator 200 (first member 210) is decreased.

Here, the load (elastic force of first member 210) acting on first member 210 is preferably larger than the load (elastic force of second member 220) acting on second member 220 in a region (region of T50 to T90 in FIG. 14) in which at least the thickness of separator 200 (first member 210) is 50% to 90% of thickness T that is under application of no load (the same applies to each example of curves 20A, 20B). More preferably, the load (elastic force of first member 210) acting on first member 210 is larger than the load (elastic force of second member 220) acting on second member 220 in a region (region of T40 to T95 in FIG. 14) in which at least the thickness of separator 200 (first member 210) is 40% to 95% of thickness T that is under application of no load (the same applies to each example of curves 20A, 20B).

In this way, second member 220 can be provided so as not to affect the deformation absorption property of first member 210 excessively within a practical use range of separator 200.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery assembly comprising:
a plurality of battery cells arranged in a first direction;
a separator disposed between the plurality of battery cells; and
a restraint member that restrains the plurality of battery cells and the separator along the first direction, wherein
the separator includes
a first member including a base portion and a plurality of protrusions each protruding from the base portion in the first direction, and
a second member disposed between the plurality of protrusions, the second member having a higher heat insulation property than a heat insulation property of the first member, the second member being more likely to be deformed than the first member.

2. The battery assembly according to claim 1, wherein in a state in which the separator is detached from the battery assembly, a protruding height of each of the plurality of protrusions is larger than a thickness of the second member.

3. The battery assembly according to claim 1, wherein an outer size of the first member and an outer size of the second member are substantially equal to each other.

4. The battery assembly according to claim 1, wherein
in a state in which the separator is detached from the battery assembly, a protruding height of each of the plurality of protrusions is larger than a thickness of the second member, and
an outer size of the first member and an outer size of the second member are substantially equal to each other.

5. The battery assembly according to claim 1, wherein the base portion of the first member and the plurality of protrusions are integrally molded.

6. The battery assembly according to claim 1, wherein
in a state in which the separator is detached from the battery assembly, a protruding height of each of the plurality of protrusions is larger than a thickness of the second member, and
the base portion of the first member and the plurality of protrusions are integrally molded.

7. The battery assembly according to claim 1, wherein
an outer size of the first member and an outer size of the second member are substantially equal to each other, and
the base portion of the first member and the plurality of protrusions are integrally molded.

8. The battery assembly according to claim 1, wherein
in a state in which the separator is detached from the battery assembly, a protruding height of each of the plurality of protrusions is larger than a thickness of the second member,
an outer size of the first member and an outer size of the second member are substantially equal to each other, and
the base portion of the first member and the plurality of protrusions are integrally molded.

9. The battery assembly according to claim 1, wherein the second member is composed of a foamed resin.

10. The battery assembly according to claim 1, wherein
in a state in which the separator is detached from the battery assembly, a protruding height of each of the plurality of protrusions is larger than a thickness of the second member, and
the second member is composed of a foamed resin.

11. The battery assembly according to claim 1, wherein
an outer size of the first member and an outer size of the second member are substantially equal to each other, and
the second member is composed of a foamed resin.

12. The battery assembly according to claim 1, wherein
the base portion of the first member and the plurality of protrusions are integrally molded, and
the second member is composed of a foamed resin.

13. The battery assembly according to claim 1, wherein
in a state in which the separator is detached from the battery assembly, a protruding height of each of the plurality of protrusions is larger than a thickness of the second member,
an outer size of the first member and an outer size of the second member are substantially equal to each other,
the base portion of the first member and the plurality of protrusions are integrally molded, and
the second member is composed of a foamed resin.

14. A method of manufacturing a battery assembly, the method comprising:
preparing a plurality of battery cells and a separator;
arranging the plurality of battery cells and the separator alternately in a first direction; and
restraining the plurality of battery cells and the separator along the first direction, wherein
the preparing of the separator includes
preparing a first member including a base portion and a plurality of protrusions protruding from the base portion in the first direction, and
providing a second member disposed between the plurality of protrusions, the second member having a higher heat insulation property than a heat insulation property of the first member, the second member being more likely to be deformed than the first member, and
the preparing of the first member includes causing a protruding height of each of the plurality of protrusions to be larger than a thickness of the second member.

15. The method of manufacturing the battery assembly according to claim 14, wherein the preparing of the separator includes disposing the second member composed of a foamed resin between the plurality of protrusions of the first member by foaming a resin in a recess surrounded by a series of the protrusions of the first member.
